(19) United States
(12) Patent Application Publication
(10) Pub. No.: US 2014/0225031 A1
(43) Pub. Date: Aug. 14, 2014

(54) LITHIUM-RICH LITHIUM METAL COMPLEX OXIDE

(71) Applicant: TANAKA CHEMICAL CORPORATION, Fukui-City, Fukui (JP)

(72) Inventors: Taiki Yasuda, Fukui-City (JP); Takaaki Masukawa, Fukui-City (JP)

(21) Appl. No.: 14/346,258

(22) PCT Filed: Sep. 26, 2012
(86) PCT No.: PCT/JP2012/074665

§ 371 Date: Mar. 20, 2014

(30) Foreign Application Priority Data
Sep. 29, 2011 (JP) 2011-215183

(51) Int. Cl. H01M 4/505; H01M 4/525

(52) U.S. Cl. CPC H01M 4/505; H01M 4/525
USPC 252/182.1; 429/224; 423/599; 423/594.4

(57) ABSTRACT

A lithium-rich lithium metal complex oxide contains at least 50 mol % of Mn with respect to a total amount of metals other than lithium, and at least one other metal. The lithium metal complex oxide has a tapped density in a range of 1.0 g/ml to 2.0 g/ml.

### CROSS REFERENCE TO RELATED APPLICATIONS

This is the National Stage of International Application No. PCT/JP2012/074665, filed Sep. 26, 2012, which claims the benefit of Japanese Patent Application No. 2011-215183, filed Sep. 29, 2011, the disclosure of which are hereby incorporated by reference in their entirety.

### TECHNICAL FIELD

The present disclosure belongs to the field of lithium-ion batteries, and more specifically, mainly relates to a lithium-rich lithium metal complex oxide that is useful as a positive electrode active material of lithium-ion batteries.

### BACKGROUND ART

A positive electrode active material that can be used for 4-volt high-energy density type lithium secondary batteries may be, in addition to LiNiO₂, LiCoO₂ and LiMn₂O₄. Batteries using LiCoO₂ as a positive electrode active material is already commercially available.

However, since cobalt is poor in its amount of resource and expensive, it is not suitable for mass production due to the spread of batteries. Considering an amount of resource and the price, manganese compounds are promising positive electrode materials. A manganese dioxide, which can be used as a raw material, is currently being mass-produced as a dry battery material. LiMn₂O₄ having a spinel structure has a drawback that the capacity decreases as the cycles are repeated. In order to overcome such a drawback, there have been efforts to add Mg or Zn (Thackeray et al., Solid State Ionics, 69, 59 (1994)), and to add Co, Ni, or Cr (Okada et al., electric battery technology, Vol. 5, (1993)), and their efficiencies have already been elucidated.

It has been found that, when discharging and charging are repeated, stoichiometric LiMn₂O₄ becomes a lithium-rich spinel compound having a low capacity, and gradually shows a stable capacity. Based on this fact, it is also found that cycle characteristics improve by using a lithium-rich spinel (Yoshio, et. al., Electrochem. Soc., 143, 625 (1996)).

Doping of a dissimilar metal is also effective in improving cycle characteristics and a greater capacity can be obtained by making a structure of a 16d site as Li, Mn, M (Ni, Co, Fe, Cr and Cu), as compared to a case where it is simply Li and Mn.

### DOCUMENT LIST

### Patent Document(s)

Non-Patent Document 1: Solid State Ionics, 69, 59 (1994)
Non-Patent Document 2: J. Electrochem. Soc., 143, 625 (1996)

However, when a dissimilar element is doped into a lithium manganate, there is generally a problem that crystals obtained are light and cannot achieve a sufficient density. When the lithium metal complex oxide has a low density, a sufficient electrode density of a lithium-ion battery cannot be achieved.

It is an object of the present disclosure to provide a lithium metal complex oxide and a method of producing a lithium metal complex oxide that do not have the aforementioned drawbacks. Further, the present disclosure provides a metal complex hydroxide useful as a precursor of the lithium metal complex oxide, a method of producing thereof, and a positive electrode material for a lithium-ion battery and a lithium-ion battery in which the above lithium metal complex oxide is used.

### SUMMARY

In order to solve the aforementioned problem, according to a first aspect of the present disclosure, a lithium-rich lithium metal complex oxide contains at least 50 mol % of Mn with respect to a total amount of metals other than lithium, and at least one other metal, the lithium metal complex oxide having a tapped density in a range of 1.0 g/ml to 2.0 g/ml.

According to the lithium metal complex oxide of a second aspect of the present disclosure, an intensity ratio of a diffraction peak around 45° to a diffraction peak of around 19° obtained by a powder X-ray diffraction technique is greater than or equal to 1.20 and less than or equal to 1.60.

According to the lithium metal complex oxide of a third aspect of the present disclosure, an average particle diameter (D50) is in a range of 1 μm to 10 μm.

According to the lithium metal complex oxide of a fourth aspect of the present disclosure, a molar ratio (Li/Me) of Li with respect to metals other than lithium satisfies:

1<Li/Me≦2.

According to the lithium metal complex oxide of a fifth aspect of the present disclosure, the other metal is at least one metal selected from a group consisting of Ni, Co, Sc, Ti, V, Cr, Fe, Cu, Zn, Y, W, Zr, Nb, Mo, Pd and Cd.

According to a sixth aspect of the present disclosure, the lithium metal complex oxide is obtained by baking a metal complex hydroxide with a lithium compound, the metal complex hydroxide being obtained by a coprecipitation process carried out without a complexing agent and containing at least 50 mol % of Mn with respect to a total amount of metals and at least one other metal, and having a tapped density in a range of 1.0 g/ml to 2.0 g/ml.

According to a seventh aspect of the present disclosure, a method of producing the lithium metal complex oxide includes baking a metal complex hydroxide with a lithium compound, the metal complex hydroxide being obtained by a coprecipitation process carried out without a complexing agent and containing at least 50 mol % of Mn with respect to a total amount of metals, and at least one other metal, and having a tapped density in a range of 1.0 g/ml to 2.0 g/ml.

According to the production method of an eight aspect of the present disclosure, the coprecipitation process is a continuous coprecipitation process.

According to a ninth aspect of the present disclosure, a metal complex hydroxide is obtained by a coprecipitation process carried out without a complexing agent and containing at least 50 mol % of Mn with respect to a total amount of metals, and at least one other metal, and having a tapped density in a range of 1.0 g/ml to 2.0 g/ml.

According to a tenth aspect of the present disclosure, a method of producing the metal complex hydroxide includes coprecipitating a metal by neutralizing an aqueous acidic solution including at least 50 mol % of Mn with respect to a total amount of metals, and at least one other metal by an alkali metal hydroxide without using a complexing agent.

According to an eleventh aspect of the present disclosure, the method of producing includes coprecipitating the metal continuously.

According to a twelfth aspect of the present disclosure, a positive electrode material for a lithium-ion battery includes the aforementioned lithium metal complex oxide.

According to a thirteenth aspect of the present disclosure, a lithium-ion battery includes the aforementioned positive electrode material.

The lithium metal complex oxide of the present disclosure has a high density, and thus a lithium-ion battery having a high positive electrode density can be obtained by using such a lithium metal complex oxide.

### BRIEF DESCRIPTION OF THE DRAWINGS

FIG. 1 FIG. 1 is a diagram showing SEM images of metal complex hydroxides obtained by Example 1, Example 2 and Comparative Example 1, respectively.

FIG. 2 FIG. 2 is a diagram showing SEM images of lithium metal complex oxides obtained by Example 3, Example 4 and Comparative Example 2.

### DESCRIPTION OF THE PREFERRED EMBODIMENTS

Hereinafter, the present disclosure will be described in detail by referring to embodiments.

A lithium-rich lithium metal complex oxide of the present disclosure contains at least 50 mol % of Mn with respect to a total amount of metals other than lithium, and at least one other metal and having a tapped density in a range of 1.0 g/ml to 2.0 g/ml.

An atomic ratio between lithium and metals other than lithium (Li/Me) of the lithium-rich lithium metal complex oxide of may be, for example, greater than 1, and preferably, 1<Li/Me≦2, and more preferably, 1.06≦Li/Me≦1.8.

In the lithium-rich lithium metal complex oxide of the present disclosure, a ratio of Mn may be at least 50 mol % of a total amount of metals other than lithium, and preferably, in a range of 60 mol % to 90 mol % to stably form a lithium-rich layer structure.

Other metal may be at least one metal selected from a group consisting of Ni, Co, Sc, Ti, V, Cr, Fe, Cu, Zn, Y, W, Zr, Nb, Mo, Pd and Cd, but it is not limited thereto. A typical lithium-rich lithium metal complex oxide may be lithium transition metal complex oxide expressed as:

Li[LiₓMn_{y}M_{z}]O₂(0<x,0<y,0<z,y/(y+z)≧0.5,x+y+z=1),

where M is one or more metallic element selected from transition metals. The transition metal is preferably at least one transition metal selected from Ti, V, Cr, Fe, Co, Ni, Mo and W, and particularly preferably at least one transition metal selected from V, Cr, Fe, Co and Ni.

Further, the lithium-rich lithium metal complex oxide of the present disclosure has a higher density than that of the related art, and its tapped density is 1.0 g/ml to 2.0 g/ml, and preferably, greater than or equal to 1.5 g/ml. A bulk density is normally 0.6 g/ml to 1.2 g/ml, and preferably, greater than or equal to 0.7 g/ml. When an average particle size (D50) is too small, the density tends to decrease. When D50 is too large, since a reaction interface with an electrolytic solution decreases and an electric battery characteristic tends to decrease, it is preferably in a range of 1 μm to 10 μm, and particularly, 3 μm to 8 μm. When a specific surface area by the BET method is too large, the density tends to decrease. When it is too small, since a reaction interface with an electrolytic solution decreases and an electric battery characteristic tends to decrease, a range of 0.5 m²/g to 1.0 m²/g is preferable, and, 0.6 m²/g to 0.8 m²/g is more preferable.

In the lithium-rich lithium metal complex oxide of the present disclosure, considering a stability of the structure and a balance of the discharge and charge capacity, it is preferable that an intensity ratio of a diffraction peak around 45° with respect to a diffraction peak of around 19° obtained by a powder X-ray diffraction technique is greater than or equal to 1.20 and less than or equal to 1.60, and particularly, greater than or equal to 1.30 and less than or equal to 1.60.

As a production method of the lithium-rich lithium metal complex oxide of the present disclosure, it is obtained by baking a metal complex hydroxide with a lithium compound, the metal complex hydroxide containing at least 50 mol % of Mn with respect to a total amount of metals, and at least one other metal, and having a tapped density in a range of 1.0 g/ml to 2.0 g/ml.

The metal complex hydroxide can be produced by a so-called continuation method including, preferably, while providing a sufficient stirring in a reaction vessel, continuously supplying at least 50 mol % of Mn with respect to a total amount of metals, an acidic aqueous solution containing the aforementioned other metal, and an alkali metal hydroxide, under an inert gas atmosphere, continuously growing crystal, and continuously retrieving an obtained precipitate. In this case, in a continuous method of the related art, an ammonium ion supplier such as ammonia was supplied as a complexing agent to a reaction vessel in which a neutralizing reaction took place. This is because it was considered that a high-density particle growth is possible by growing a particle by using metal ions as an ammonium complex salt and decreasing a concentration gradient for pH in an aqueous solution. However, unexpectedly, with the findings by the present inventors, it was elucidated that a particle growth becomes uniform and a spherical property improves when a complexing agent was not added when producing the metal complex hydroxide of the present disclosure including Mn at a high concentration. Although the cause for this is not certain, it is considered that, in the related art, manganese does not form a stable complex, and thus a difference in reaction speeds increases between neutralizing reactions of other metal salts such as a nickel salt and a uniform particle growth was not possible, whereas in the present disclosure, a neutralizing reaction is performed without using an ammonium complex salt, and thus a particle growth becomes uniform and a spherical property has improved.

It is preferable that pH during the neutralizing reaction is in a range of 10 to 13, and particularly, 10 to 12. In the continuous method, in order to achieve a uniform particle growth, it is preferable to control a variation of pH in a range of ±0.5, and particularly, ±0.05. The reaction temperature is preferably 30° C. to 80° C., and particularly, 40° C. to 60° C., but not particularly limited thereto. Further, in order to increase a density of hydroxide to be obtained, a metal ion concentration of an aqueous acidic solution including at least 50 mol % of Mn with respect to a total amount of metals and at least one other metal is preferably in a range of 0.7 mol/L and 2.0 mol/L, and particularly, 1.4 mol/L to 2.0 mol/L. In order to obtain a sufficient grinding effect between particles and to obtain high density particles, a number of rotations of stirring during the reaction is preferably in a range of 1000 rpm to 3000 rpm, and particularly preferably 1200 rpm to 2000 rpm.

The metal complex hydroxide thus obtained has a high density, and a tapped density is usually in a range of 1.0 g/ml to 2.0 g/ml. A bulk density is preferably 0.6 g/ml to 1.2 g/ml, and particularly, greater than or equal to 0.7 g/ml is preferable. When an average (secondary) particle size (D50) is too small, the density tends to decrease. When D50 is too large, a reaction interface of an active material with an electrolytic solution decreases and battery characteristics tend to decrease, and thus it is preferable to be in a range of 1 μm to 10 μm, and particularly 3 μm to 8 μm. When a specific surface area by the BET method is too large, the density tends to decrease. When it is too small, a reaction interface of an active material with an electrolytic solution tend to decrease and battery characteristics tend to decrease, and thus it is preferably in a range of 15 m²/g to 22 m²/g, and more preferably, 18 m²/g to 21 m²/g.

A baking temperature of the aforementioned metal complex hydroxide and lithium compounds such as lithium hydroxide and the lithium carbonate is preferably greater than or equal to 900° C. and less than or equal to 1100° C., and more preferably, greater than or equal to 900° C. and less than or equal to 1050° C., and still more preferably, from 950° C. to 1025° C. When the baking temperature is below 900° C., it is likely to cause a drawback that an energy density (discharge capacity) and a high rate discharge performance decrease. In a region below this, a structural factor disturbing a movement of the Li may be inherent.

On the other hand, when a baking temperature exceeds 1100° C., it is likely to cause a problem in the preparation such as it is difficult to obtain a compound oxide of a target composition due to volatilization of Li and a problem that battery characteristics may decrease due to a high density of the particles. This is due to the fact that above 1100° C., a primary particle growth rate increases and a crystal particle of the complex oxide becomes too large, and it is also considered that the cause may reside in that a Li loss quantity has locally increased and has become structurally unstable. Furthermore, as the temperature becomes higher, an element substitution between a site occupied by a Li element and a site occupied by Mn and other elements is produced extremely, and a discharge capacity decreases due to inhibition of Li conduction. With the baking temperature being in a range of greater than or equal to 950° C. and less than or equal to 1025° C., a battery having a particularly high energy density (discharge capacity) and an improved charge/discharge cycle performance can be manufactured. The baking time is preferably 3 hours to 50 hours. When the baking time is over 50 hours, although it is not problematic regarding the battery characteristics, it tends to have substantially lower battery characteristics due to volatilization of Li. If the baking time is less than 3 hours, there is a tendency of a bad crystalline development, and worse battery characteristics. Before the baking, in order to prevent segregation of Li, it is effective to perform calcining (e.g., see Japanese Laid-Open Patent Publication No. 2011-29000). Such calcining is preferably performed at a temperature in the range of 300° C. to 900° C. for 1 to 10 hours.

Hereinafter, a positive electrode material for a lithium-ion battery and a lithium-ion battery of the present disclosure will be described.

The positive electrode material for a lithium-ion battery of the present disclosure includes the aforementioned lithium metal complex oxide. Depending on purposes, commonly known positive electrode active materials such as a lithium cobalt oxide, a lithium nickel oxide, a lithium manganese oxide, and the lithium cobalt manganese nickel oxide may be added to a positive electrode material for a lithium-ion battery of the present disclosure.

Further, the positive electrode material for a lithium-ion battery of the present disclosure may contain other compounds, and the other compounds may be a group I compound such as CuO, Cu₂O, Ag₂O, CuS and CuSO₄, a group IV compound such as TiS₂, SiO₂ and SnO, a group V compound such as V₂O₅, V₆O₁₂, VOₓ, Nb₂O₅, Bi₂O₃ and Sb₂O₃, a group VI compound such as CrO₃, Cr₂O₃, MoO₃, MoS₂, WO₃ and SeO₂, a group VII compound such as MnO₂ and Mn₂O₃, a group VIII compound such as Fe₂O₃, FeO, Fe₃O₄, Ni₂O₃, NiO, CoO₃ and CoO, an electrically-conductive polymer compound such as disulfide, polypyrrole, polyaniline, polyparaphenylene, polyacetylene and a polyacene based material, and pseudo graphite structure carbonaceous material.

When other compounds other than the positive electrode active material is used together, percentages of other compounds used are not limited as long as an effect of the present disclosure is not impaired. The other compounds are preferably 1% to 50% by weight, and more preferably, 5% to 30% by weight with respect to the total weight of the positive electrode material.

The lithium-ion battery of the present disclosure is characterized by including the positive electrode material of the present disclosure, and normally provided with the positive electrode, a negative electrode for a non-aqueous electrolyte secondary battery (hereinafter, simply referred to as an “negative electrode”) and a non-aqueous electrolyte, and generally, a separator for non-aqueous electrolyte secondary battery is provided between the positive electrode and the negative electrode. An exemplary preferable non-aqueous electrolyte may take the form of an electrolyte salt contained in a nonaqueous solvent.

The non-aqueous electrolyte may be those generally suggested for the use for a lithium-ion battery. A non-aqueous solvent may be cyclic carbonate esters such as propylene carbonate, ethylene carbonate, butylene carbonate, chloroethylene carbonate and vynylene carbonate; cyclic esters such as γ-butyrolactone and γ-valerolactone; chain carbonates such as a dimethyl carbonate, diethyl carbonate and ethyl methyl carbonate; chain esters such as methyl formate, methyl acetate and methyl butyrate; tetrahydrofuran or derivatives thereof; ethers such as 1,3-dioxane, 1,4-dioxane, 1,2-dimethoxyethane, 1,4-dibutoxy ethane and methyl diglyme; nitriles such as acetonitrile and benzonitrile; dioxolane or derivatives thereof; ethylene sulfide, sulfolane, sultone or derivatives thereof, and these ionized compounds may be used alone or as a mixture of two or more thereof, but it is not limited thereto.

The electrolyte salt may be, for example, an inorganic ion salt including one of lithium (Li), sodium (Na) or potassium (K) such as LiClO₄, LiBF₄, LiAsF₆, LiPF₆, LiSCN, LiBr, LiI, Li₂SO₄, NaClO₄, NaI, NaSCN, NaBr, KClO₄ and KSCN and an organic ion salt such as LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F₅SO₂)₃, (CH₃)₄NBF₄, (CH₃)₄NBr, (C₂H₅)₄NClO₄, (C₂H₅)₄NI, (C₃H₇)₄NBr, (n-C₄H₉)₄NClO₄, (n-C₄H₉)₄NI, (C₂H₅)₄N-maleate, (C₂H₅)₄N-benzoate, (C₂H₅)₄N-phtalate, lithium stearyl sulfonate, lithium octyl sulfonate and lithium dodecyl benzene sulphonate, taken alone or as a mixture of two or more thereof.

Further, it is further desirable to use a mixture of an inorganic ion salt such as LiBF₄ and LiPF₆ and a lithium salt having a fluoroalkyl group such as LiN(C₂F₅SO₂)₂, since viscosity of the electrolyte can be further decreased, a low temperature characteristic can be further increased.

In order to positively obtain an electric battery having a high electric battery characteristic, the concentration of an electrolyte salt in a non-aqueous electrolyte is preferably, 0.1 mol/liter to 5 mol/liter, and more preferably, 1 mol/liter to 2.5 mol/liter.

The positive electrode preferably has the positive electrode active material including the lithium metal complex oxide of the present disclosure as a main component. The positive electrode is preferably manufactured by, for example, kneading the lithium metal complex oxide of the present disclosure with a conducting agent, a binding agent, and further a filler, as necessary, into a positive electrode material, thereafter applying or pressure bonding the positive electrode material to a foil or a lath board as a current collector, and heating at a temperature of about 50° C. to 250° C. for about two hours. The content of positive electrode active material with respect to the positive electrode is usually 80% to 99% by weight, and preferably, 85% to 97% by weight.

The negative electrode has a negative electrode material as a main component. The negative electrode material may be selected from any material as long as lithium ions can be stored and emitted. For example, the negative electrode material may be a lithium metal, a lithium alloy (an alloy containing lithium metal such as lithium-aluminum, lithium-lead, lithium-tin, lithium-aluminum-tin, lithium-gallium and Wood's alloy), a lithium complex oxide (lithium-titanium), silicon nitride, and other alloy or a carbon material that can store and emit lithium (e.g., graphite, hard carbon, low temperature baked carbon, amorphous material carbon). Among these material, graphite is preferable as a negative electrode material since it has an operation potential which is extremely near a metal lithium and can reduce self-discharge when lithium salt is employed as electrolyte salts and an irreversible capacity in the discharge and charge can be reduced. For example, artificial graphite and natural graphite are preferable. Particularly, graphite having a negative electrode material surface modified with amorphous carbon or the like is desirable since it produces less gas during the charging.

A result of analysis by an X-ray diffraction or the like of graphite that can be preferably used is as indicated below:

Lattice spacing (d002): 0.333 nm to 0.350 nm;
Size of crystallite in a-axis direction La: greater than or equal to 20 nm; Size of crystallite in c-axis direction Lc: greater than or equal to 20 nm; and Real density: 2.00 g/cm³ to 2.25 g/cm³.
Graphite can also be reformed by adding a metal oxide such as a tin oxide or a silicon oxide, phosphorus, boron and amorphous carbon. Particularly, by reforming a surface of graphite by the aforementioned method, it is possible and desirable to inhibit decomposition of the electrolyte and to increase battery characteristics. Further, a lithium metal, lithium-aluminum, lithium-lead, lithium-tin, lithium-aluminum-tin, lithium-gallium and a lithium metal component alloy such as and Wood's alloy may be used together with graphite, or graphite or the like in which lithium is inserted by performing an electrochemical reduction in advance can be used as a negative electrode material. The content of the negative electrode material with respect to the negative electrode is normally 80% to 99% by weight, and preferably 90% to 98% by weight.

It is desirable that powders of the positive electrode active material and powders of the negative electrode material have an average particle size of less than or equal to 100 μm. Particularly, it is desirable that the powders of the positive electrode active material is less than or equal to 10 μm for the purpose of improving high output characteristics of the electric battery. In order to obtain powders with a predetermined shape, a mill or a classifier is used. For example, a mortar, a ball mill, a sand mill, an oscillation ball mill, a planetary ball mill, a jet mill, a counter jet mill, a spinning air jet mill or a sieve is used. A wet grinding may be employed in which water or organic solvents such as hexane coexist during the grinding. A classifying method is not particularly limited, and a sieve or a wind force classifier, both dry and wet types, is used as needed.

In the above, the positive electrode material and the negative electrode material which are main components of the positive electrode and negative electrode have been described in detail. In addition to the main components, the positive electrode and the negative electrode may contain a conducting agent, a binding agent, a thickener, a filler and the like as other components.

The conducting agent is not limited as long as it is an electronically conductive material that does not have an adverse effect on the cell characteristics, and usually contains one or a mixture of a conductive material such as natural graphite (vein graphite, flake graphite, amorphous graphite, or the like) artificial graphite, carbon black, acetylene black, Ketjenblack, carbon whisker, carbon fiber, metal (copper, nickel, aluminum, silver, gold, or the like) powder, metallic fiber and a conductive ceramics material.

Among the above, from electronic conduction and coating points of view, acetylene black is desirable as a conducing agent. The amount of addition of the conducting agent is preferably 0.1% to 50% by weight, and particularly preferably 0.5% to 30% by weight with respect to a total weight of the positive electrode or the negative electrode. It is particularly desirable to grind acetylene black into ultrafine particles of 0.1 μm to 0.5 μm, since an amount of required carbon can be reduced. The above mixing method is a physical mixing and it is ideally a uniform mixing. Accordingly, a powder mixer such as a V type mixer, an S type mixer, a stone mill, a ball mill and a planetary ball mill can be used for dry or wet mixing.

The binding agent can be usually one or a mixture of two or more of a thermoplastic resin such as polytetrafluoroethylene (PTFE), polyvinylidene fluoride (PVdF), polyethylene, and polypropylene, polymers having rubber elasticity such as ethylene-propylene-diene terpolymer (EPDM), sulfonate EPDM, styrene-butadiene rubber (SBR), and fluorine rubber. An amount of addition of the binding agent is preferably 1% to 50% by weight, particularly preferably 2% to 30% by weight with respect to the total weight of the positive electrode or the negative electrode.

Particularly, the positive electrode of the present disclosure preferably contains a conductive carbon material of greater than or equal to 1% by weight with respect to positive electrode active material and a binding agent having ion conductivity by containing an electrolytic solution. “The binding agent having ion conductivity by containing an electrolytic solution” may be, when using an electrolytic solution in which LiPF₆ is used an electrolyte and ethylene carbonate, diethylene carbonate or a dimethyl carbonate is used as a solvent, polyvinylidene fluoride (PVdF) and polyethylen (polyethylen oxide) can be preferably used among the aforementioned binding agents.

The thickener may be, usually, one or a mixture of two or more of polysaccharides such as carboxymethylcellulose and methylcellulose. Regarding the thickener having a functional group that reacts with lithium such as polysaccharides, it is desirable to deactivate the functional group by a process such as methylation. The amount of additive of the thickener is preferably 0.5% to 10% by weight, and particularly preferably, 1% to 2% by weight with respect to the total amount of the positive electrode or the negative electrode.

The filler may be of any material as long as it does not have an adverse effect on battery characteristics. Usually, polypropylene or polyethylene, which is an olefin-based polymer, amorphous silica, alumina, zeolite, glass, carbon, or the like are used. The amount of additive of the filler is preferably 30% by weight or less with respect to the total weight of the positive electrode or the negative electrode.

The positive electrode and the negative electrode are preferably produced by mixing a main component (the positive electrode active material in a case of the positive electrode and the negative electrode material in a case of the negative electrode), a conducting agent and a binding agent into a solvent such as N-methylpyrrolidon and toluene to prepare a slurry, and applying and drying the slurry on the current collector to be described in detail below. In the coating method above, it is desirable that a coating is applied with an arbitrary thickness and an arbitrary shape using measures such as roller coating such as an applicator roll, screen coating, a doctor blade method, spin-coating, a bar coater, but it is not limited thereto.

The current collector may be any electronic conductor that does not have an adverse effect in the constructed electric battery. For example, a current collector for the positive electrode may be aluminum, titanium, stainless steel, nickel, baked carbon, an electrically-conductive polymer and a conductive glass, as well as aluminum or copper with a surface thereof being processed with carbon, nickel, titanium, silver or the like, for the purpose of improving adhesive property, conductivity and oxidation resistance. A current collector for the negative electrode may be copper, nickel, iron, stainless steel, titanium, aluminum, baked carbon, an electrically-conductive polymer, an electroconductive glass and an Al—Cd alloy, as well as copper or the like with a surface there of being processed with carbon, nickel, titanium, silver or the like for the purpose of providing adhesive property, conductivity and reduction-resistant property. It is also possible to provide oxidization treatment on a surface of these materials.

The shape of the current collector may be, in addition to a foil, a film, a sheet, a net, a punched or expanded material, a lath body, a porous body, a foam body, and formed body of a group of fibers. There is no particular limitation to the thickness, but the one having a thickness of 1 μm to 500 μm is used. Among these current collectors, an aluminum foil having a good oxidation-resistance is preferable as a positive electrode and a copper foil, a nickel foil, an iron foil and an alloy foil including a part of them, having a good reduction-resistance and conductivity is preferable as a negative electrode. Further, it is preferable that the foil has a surface roughness of a rough surface of greater than or equal to 0.2 μmRa to thereby improve adhesiveness between the positive electrode active material or the positive electrode material and the current collector. Thus, it is preferable to use an electrolytic foil since it has such a rough surface. Particularly, an electrolytic foil on which a roughening process is applied is preferable. Further, when coating both faces the foil, it is desirable to make the surface roughness of the foil to be the same or approximately equal.

As a separator for a non-aqueous electrolyte battery, it is preferable to use a porous membrane, a nonwoven fabric or the like showing a good rate property, alone or together. A material composing a separator for non-aqueous electrolyte battery is, for example, a polyolefin resin represented by polyethylene or polypropylene, a polyester resin represented by polyethylene terephthalate and polybutylene terephthalate, a polyvinylidene fluoride, a vinylidene fluoride-hexafluoropropylene copolymer, a vinylidene fluoride-perfluorovinyl ether copolymer, a vinylidene fluoride-tetrafluoroethylene copolymer, a vinylidene fluoride-trifluoroethylene copolymer, a vinylidene fluoride-fluoro ethylene copolymer, a vinylidene fluoride-hexafluoroacetone copolymer, a vinylidene fluoride-ethylene copolymer, a vinylidene fluoride-propylene copolymer, a vinylidene fluoride-trifluoropropylene copolymer, a vinylidene fluoride-tetrafluoroethylene-hexafluoropropylene copolymer, and a vinylidene fluoride-ethylene-tetrafluoroethylene copolymer.

A porosity of a separator for a non-aqueous electrolyte electric battery is preferably less than or equal to 98% by volume from an intensity point of view. Also, the porosity of the separator is preferably greater than or equal to 20% by volume from a discharge capacity point of view.

Also, the separator for a non-aqueous electrolyte battery may use a polymer gel composed of, for example, a polymer such as acrylonitrile, an ethylene oxide, a propylene oxide, methyl metacrylate, vinyl acetate, vinyl pyrrolidone and a polyvinylidene fluoride, and an electrolyte.

When the non-aqueous electrolyte is used in a gel state as above, it is preferable that there is an effect of preventing a leakage of a liquid. Further, it is desirable to use the aforementioned porous membrane or nonwoven fabric together with a polymer gel as the non-aqueous electrolyte battery separator, since a liquid retaining property of the electrolyte will improve. That is, by forming a film on which a solvent hydrophilic polymer having a thickness of a few μm or less is coated on a surface and a microporous wall surface of a polyethylene microporous film and holding the electrolyte in the micropores of the film, the solvent hydrophilic polymer gelates.

The aforementioned solvent hydrophilic polymer may be polyvinylidene fluoride as well as a polymer in which an acrylate monomer having an ethylene oxide group or an ester group, an epoxy monomer, and a monomers having an isocyanate group is cross-linked. The monomer can cause a cross-link reaction utilizing heating or ultraviolet radiation (UV) using a radical initiator together, and, using an active ray such as an electron beam (EB).

For the purpose of controlling strength and physical property, the aforementioned solvent hydrophilic polymer may be used with a physical property adjusting agent in a rage where the formation of a cross-linked body is not interrupted being mixed therein. Exemplary physical property adjusting agent includes inorganic fillers {silicon oxide, titanium oxide, aluminum oxide, magnesium oxide, zirconium oxide, zinc oxide, metal oxide such as iron oxide, metal carbonate such as calcium carbonate or magnesium carbonate} and polymers {polyvinylidene fluoride, vinylidene fluoride/hexafluoropropylene copolymer, polyacrylonitrile or polymethylmethacrylate}. The amount of additives of the physical property adjusting agent is usually less than or equal to 50% by weight, and preferably less than or equal to 20% by weight for a cross-linked monomer.

The lithium-ion battery of the present disclosure is preferably manufactured by, for example, introducing an electrolyte before laminating or after having laminated the separator for non-aqueous electrolyte battery, the positive electrode and the negative electrode, and finally sealing with an external material. In a battery in which a power generating element formed by laminating a positive electrode and a negative electrode across a separator for non-aqueous electrolyte battery is rolled up, it is preferable that the electrolyte is introduced into the power generating element before and after rolling up. The liquid-introducing method may be a method in which liquid is introduced under a normal pressure, but a vacuum impregnation method and a pressurized impregnation method are also applicable.

The material of the external body of the battery may be, as an example, nickel plated iron and stainless steel, aluminum, and a metal resin composite film. For example, a metal resin composite film having a configuration in which a metal foil is sandwiched between resin films is preferable. Specific examples of the metal foil include aluminum, iron, nickel, copper, stainless steel, titanium, gold, silver, or the like, and it is not limited thereto as long as it is a foil without pinholes, and a lightweight and inexpensive aluminum foil is preferable. As a resin film on an external side of the electric battery, a resin film having a good strength against piercing such as a polyethylene terephthalate film and a nylon film is preferable, and as a resin film on an internal side of the electric battery, a film having a heat-seal property and solvent resistance such as a polyethylene film and a nylon film is preferable.

The configuration of the battery is not particularly limited, and an example includes a coin cell and a button cell having a positive electrode, a negative electrode, and a single-layered or multilayered separator, and further a cylindrical cell, a prismatic cell, and a flat cell having a positive electrode, a negative electrode, and a rolled separator.

### Examples

Hereinafter, the present disclosure will be described in a further detail with reference to examples. The following examples are for explaining the present disclosure and shall not be construed to limit the present disclosure.

### Example 1

After placing 15 L of water into a 15 L cylindrical reaction vessel equipped with a 70φ propeller stirrer having a single stirring blade and an overflow pipe, a 32% sodium hydroxide solution was added until a pH of 10.8 is reached and stirred at a rate of 1500 rpm while maintaining a temperature of 50° C. Then, a mixture of an aqueous nickel sulfate solution, an aqueous cobalt sulfate solution, and an aqueous manganese sulfate solution are mixed at an atomic ratio of Ni:Co:Mn of 20:10:70 (total amount of nickel sulfate, cobalt sulfate, and manganese sulfate being 80 g/L) was continuously added into the reaction vessel at a flow rate of 9 ml/min. During this, a 32% sodium hydroxide was added intermittently until the solution in the reaction vessel reaches a pH of 10.8, and a metal complex hydroxide was precipitated.

After 72 hours when the reaction vessel has reached a steady state, the metal complex hydroxide was continuously collected for 24 hours through the overflow pipe, rinsed with water, filtered and dried at 105° C. for 20 hours to obtain a metal complex hydroxide which is a solid solution of cobalt, manganese and nickel with an atomic ratio of 20:10:70.

The obtained metal complex hydroxide powder had a bulk density of 0.82 g/ml. A tapped density measured under the following condition was 1.24 g/ml. An average particle size (D50) measured′ by a laser diffraction/scattering particle size distribution measuring apparatus from Horiba, Ltd. was 5.17 μm, and a BET surface area measured by 4-Sorb from YUASA Ionics Corporation was 20.0 m²/g. A sodium ion content and an SO₄²⁺ content measured by ICP emission spectroscopy were 0.007% and 0.31% by mass, respectively.

Measuring Conditions for Tapped Density

The mass [A] of a 20 mL cell [C] was measured, and the crystals were filled in the cell by being allowed to naturally fall through a 48 mesh sieve. The mass of the cell after tapping 200 times [B] and a filled volume [D] were measured using “TAPDENSER KYT3000” from Seishin Enterprise Co., Ltd. equipped with a 4 cm spacer. Calculation was carried out using the following equations.

Tapped density=(B−A)/D g/ml

Bulk density=(B−A)/C g/ml

### Example 2

After placing 15 L of water into a 15 L cylindrical reaction vessel equipped with a 70φ propeller stirrer having a single stirring blade and an overflow pipe, a 32% sodium hydroxide solution was added until a pH of 10.9 is reached and stirred at a rate of 1500 rpm while maintaining a temperature of 50° C. Then, a mixture of an aqueous nickel sulfate solution, an aqueous cobalt sulfate solution, and an aqueous manganese sulfate solution are mixed at an atomic ratio of Ni:Co:Mn of 20:10:70 (total amount of nickel sulfate, cobalt sulfate, and manganese sulfate is 103 g/L) was continuously added into the reaction vessel at a flow rate of 9 ml/min. During this, a 32% sodium hydroxide was added intermittently until the solution in the reaction vessel reaches a pH of 10.9, and a metal complex hydroxide was precipitated.

After 72 hours when the reaction vessel has reached a steady state, the metal complex hydroxide was continuously collected for 24 hours through the overflow pipe, rinsed with water, filtered, dried at 105° C. for 20 hours to obtain a metal complex hydroxide which is a solid solution of cobalt, manganese and nickel of an atomic ratio of 20:10:70.

The obtained metal complex hydroxide powder had a bulk density of 0.96 g/ml. A tapped density measured under the aforementioned conditions was 1.46 g/ml. An average particle size (D50) was 5.06 μm, and a BET surface area measured by 4-Sorb from YUASA Ionics Corporation 19.3 m²/g. A sodium ion content and an SO₄²⁺ content measured by ICP emission spectroscopy were 0.007% and 0.33% by mass, respectively.

### Comparative Example 1

A metal complex hydroxide was obtained under the same conditions as in Example 1, except that, during a neutralizing reaction, an aqueous ammonium sulfate solution with an ammonia concentration being adjusted to 100 g/L was added continuously at a flow rate of 0.9 ml/min. The obtained metal complex hydroxide powder had a bulk density of 0.32 g/ml. A tapped density measured under the aforementioned conditions was 0.65 g/ml. An average particle size was 5.60 μm, and a BET surface area measured by a laser diffraction/scattering particle size distribution measuring apparatus from Horiba, Ltd. was 22.0 m²/g. A sodium ion content and an SO₄²⁺ content measured by ICP emission spectroscopy were 0.048% and 0.41% by mass, respectively.

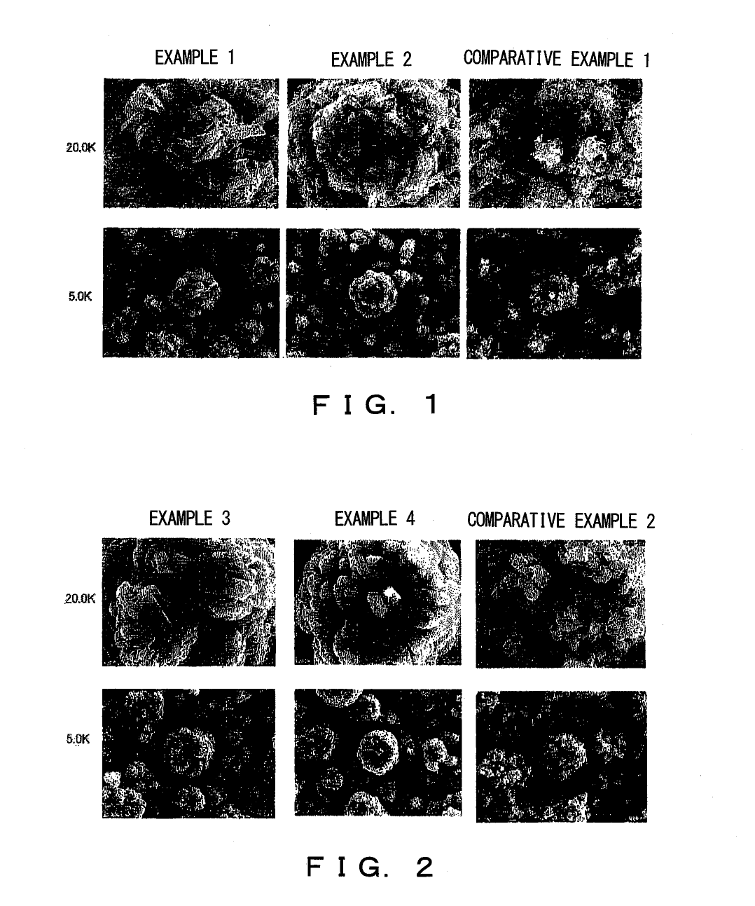

FIG. 1 is a diagram showing SEM images of the metal complex hydroxides obtained in the aforementioned Example 1, Example 2 and Comparative Example 1, respectively. In Examples 1 and 2, a primary particle is generally a quadratic prism having a minor axis of approximately 0.2 μm and a major axis of approximately 1 μm, and it can be seen that the primary particles are aggregated into a dense substantially spherical secondary particle. On the other hand, under the conditions of Comparative Example 1, it can be observed that the primary particle has a flake shape of a diameter of approximately 0.2 μm and thus the growth of the secondary particle is not sufficient. Further, in Example 2 in which a material concentration is higher as compared to Example 1, it can be considered that homogeneity and spherical property of the particle have increased and thus the densities have further improved.

### Example 3

The metal complex hydroxide obtained in Example 1 was mixed with lithium carbonate such that the Li/Me ratio is 1.545. The mixture was filled in a sheath made of alumina, heated from room temperature to 400° C. under a dry air using an electric furnace, and maintained at 400° C. for one hour. Then, the temperature was increased to 700° C., and maintained at 700° C. for five hours. Furthermore, the temperature was increased to 1000° C., and maintained at 1000° C. for ten hours. Then, it was slowly cooled to room temperature. A rate of temperature increase for each temperature increase was assumed to be 200° C./hr.

The lithium metal complex oxide thus obtained has a bulk density of 0.86 g/ml and a tapped density obtained by the aforementioned measuring method of 1.62 g/ml. Further, an average particle size (D50) was 5.97 μm, and a BET surface area was 0.70 m²/g.

### Example 4

Using the metal complex hydroxide obtained in Example 2 as a material, a lithium metal complex oxide was obtained under the conditions similar to those of Example 3. The obtained lithium metal complex oxide had a bulk density of 1.00 g/ml, and a tapped density by the aforementioned measuring method of 1.72 g/ml. Further, an average particle size (D50) was 5.90 μm, and a BET surface area was 0.59 m²/g.

As a result of X-ray diffraction measurement of the lithium metal complex oxide obtained in Examples 3 and 4 using a CuKα ray, a peak was observed at 2θ=around 18 degrees, 22 degrees, 36 degrees, 37 degrees, 38 degrees, 45 degrees, 48 degrees, 58 degrees, 64 degrees, 65 degrees, and 68 degrees, respectively. Among these, from the peak existing near 22 degrees, it was found that the powder was a lithium metal complex oxide having a lithium-rich layer structure. A ratio of an intensity of diffracted rays near 19 degrees to a ratio of an intensity of diffracted rays near 45 degrees was 1.44 and 1.24, respectively.

### Comparative Example 2

Using the metal complex hydroxide obtained in Comparative Example 1 as a material, a lithium metal complex oxide was obtained under the conditions similar to those of Example 3. The obtained lithium metal complex oxide had a bulk density of 0.47 g/ml, and a tapped density by the aforementioned measuring method of 0.90 g/ml. Further, an average particle size (D50) was 5.47 μm, and a BET surface area was 1.8 m²/g. From the peak existing near 22 degrees, it was found that the powder was a lithium metal complex oxide having a lithium-rich layer structure.

FIG. 2 is a diagram showing SEM images of lithium metal complex oxides obtained by Example 3, Example 4 and Comparative Example 2. Similarly to the case of the metal complex oxide which is a precursor, it can be seen that the lithium metal complex oxide of Examples 3 and 4 has an improved spherical property of the secondary particle as compared to Comparative Example 2.

### Example 5, Example 6 and Comparative Example 3

The lithium metal complex oxides obtained in Example 3, Example 4 and comparative example 2 were tested and evaluated by manufacturing a two-electrode evaluation cell having a negative electrode of lithium metal. Evaluation cells of Example 5, Example 6 and Comparative Example 3 were respectively manufactured as follows. To prepare the positive electrode material, an active material, a conducting agent (acetylene black) and a binder (polyvinylidene fluoride) were mixed at a weight ratio of 88:6:6, respectively, N-methyl-2-pyrrolidone was added, kneaded and dispersed to prepare a slurry. The slurry was applied to an aluminum foil using a Baker-type applicator and dried for three hours at 60° C. and for 12 hours at 120° C. The electrode after the drying was roll pressed and punched into an area of 2 cm² to provide a positive electrode plate. Also, a two-electrode type evaluation cell having a positive electrode of such positive electrode materials was manufactured. The evaluation cell was manufactured by attaching the lithium metal on a stainless steel plate to manufacture a negative electrode plate. Into a solution in which an ethylene carbonate and a dimethyl carbonate are mixed at a volume ratio of 3:7, respectively, a hexafluorolithium phosphate was dissolved so that it reaches 1 mol/L, and the thus-obtained solution was applied into a separator as an electrolytic solution. A polypropylene separator was used as the separator. A two-electrode type evaluation cell was made by sandwiching the positive electrode plate, the separator and the negative electrode plate with stainless steel plate and sealed in an external material.

In addition to the measuring of the press density and the electrode density as described below, a charge capacity, a discharge capacity and a charge-discharge efficiency of the lithium-ion battery was measured as follows.

Measuring Conditions of Positive Electrode Press Density and Electrode Density

Press Density: An apparent density of the powder when a pressure of 10 kN was applied on the active material was measured.

Electrode density: A volume of an electrode was calculated from a thickness of the electrode after the roll pressing when the positive electrode plate was manufactured (a difference obtained by subtracting a thickness of an aluminum plate from a thickness of a positive electrode plate) and a punched area of the electrode, and a value of a weight of an active material (the weight of the active material obtained by subtracting a weight of the aluminum plate from a total weight of the manufactured positive electrode plate and calculated from a weight ratio of the active material, the conducting agent and the binder).

Charge Capacity, Discharge Capacity and Charge-Discharge Efficiency of Lithium-ion Battery

Voltage control was performed on all positive electrode potential differences. The charging was such that an electric current is 0.05 C, a constant current constant potential charging of a voltage of 4.8V, and a charge end condition was made at a point where the current value has attenuated to ⅕. The discharging was such that the current was 0.05 C and a constant-current discharge of an end voltage of 2.0 V.

Results of measurements are shown in Tables 1 and 2.

TABLE 1
TABLE 1

| | | | COMPARATIVE |
|---|---|---|---|
| | EXAMPLE 5 | EXAMPLE 6 | EXAMPLE 3 |
| PRESS DENSITY | 2.454 | 2.600 | 2.220 |
| (g/ml) | | | |
| ELECTRODE | 2.474 | 2.600 | 2.382 |
| DENSITY (g/ml) | | | |

TABLE 2
TABLE 2

| | EXAMPLE 5 | | EXAMPLE 6 | | COMPARATIVE EXAMPLE 3 | |
|---|---|---|---|---|---|---|
| | INITIAL | 2 CYCLES | INITIAL | 2 CYCLES | INITIAL | 2 CYCLES |
| CHARGE CAPACITY (mAh/g) | 338.3 | 249.0 | 362.8 | 245.3 | 348.3 | 269.5 |
| DISCHARGE CAPACITY (mAh/g) | 251.7 | 252.0 | 263.1 | 249.0 | 275.0 | 271.1 |
| CHARGE-DISCHARGE EFFICIENCY (%) | 74.4 | 101.2 | 72.5 | 101.5 | 79.0 | 100.6 |
| DISCHARGE CAPACITY × | 617.7 | 618.4 | 684.1 | 647.4 | 610.5 | 601.8 |
| PRESS DENSITY (mAh/ml) | | | | | | |
| DISCHARGE CAPACITY × | 622.7 | 623.4 | 684.1 | 647.4 | 655.1 | 645.8 |
| ELECTRODE DENSITY (mAh/ml) | | | | | | |

From the results shown in Table 1, it can be seen that, using a high-density lithium metal complex oxide of the present disclosure, the press density and the electrode density of the lithium-ion battery can be improved. Also, from Table 2, it can be seen that the lithium metal complex oxide of the present disclosure sufficiently achieves the charge-discharge characteristics. Particularly, it can be seen that the lithium metal complex oxide of Example 6 is an advantageous positive electrode active material since the product of the discharge capacity and the electrode density is high.

What is claimed is:

1. A lithium-rich lithium metal complex oxide containing at least 50 mol % of Mn with respect to a total amount of metals other than lithium, and at least one other metal, the lithium metal complex oxide having a tapped density in a range of 1.0 g/ml to 2.0 g/ml.

2. The lithium metal complex oxide according to claim 1, wherein an intensity ratio of a diffraction peak around 45° to a diffraction peak of around 19° obtained by a powder X-ray diffraction technique is greater than or equal to 1.20 and less than or equal to 1.60.

3. The lithium metal complex oxide according to claim 1, wherein an average particle diameter (D50) is in a range of 1 μm to 10 μm.

4. The lithium metal complex oxide according to claim 1, wherein a molar ratio (Li/Me) of Li with respect to metals other than lithium satisfies:
1<Li/Me≦2.

5. The lithium metal complex oxide according to claim 1, wherein the other metal is at least one metal selected from a group consisting of Ni, Co, Sc, Ti, V, Cr, Fe, Cu, Zn, Y, W, Zr, Nb, Mo, Pd and Cd.

6. The lithium metal complex oxide according to claim 1, obtained by baking a metal complex hydroxide with a lithium compound, the metal complex hydroxide being obtained by a coprecipitation process carried out without a complexing agent and containing at least 50 mol % of Mn with respect to a total amount of metals, and at least one other metal, and having a tapped density in a range of 1.0 g/ml to 2.0 g/ml.

7. A method of producing the lithium metal complex oxide of claim 1, comprising:
baking a metal complex hydroxide with a lithium compound, the metal complex hydroxide being obtained by a coprecipitation process carried out without a complexing agent and containing at least 50 mol % of Mn with respect to a total amount of metals, and at least one other metal, and having a tapped density in a range of 1.0 g/ml to 2.0 g/ml.

8. The production method according to claim 7, wherein the coprecipitation process is a continuous coprecipitation process.

9. A metal complex hydroxide obtained by a coprecipitation process carried out without a complexing agent and containing at least 50 mol % of Mn with respect to a total amount of metals, and at least one other metal, and having a tapped density in a range of 1.0 g/ml to 2.0 g/ml.

10. A method of producing the metal complex hydroxide of claim 9, comprising:
coprecipitating a metal by neutralizing an aqueous acidic solution including at least 50 mol % of Mn with respect to a total amount of metals, and at least one other metal by an alkali metal hydroxide without using a complexing agent.

11. The production method according to claim 10, comprising coprecipitating the metal continuously.

12. A positive electrode material for a lithium-ion battery including the lithium metal complex oxide of claim 1.

13. A lithium-ion battery comprising the positive electrode material of claim 12.
